(19) United States
(12) Patent Application Publication
(10) Pub. No.: US 2009/0094138 A1
(43) Pub. Date: Apr. 9, 2009

(54) SYSTEM AND METHOD FOR CALCULATING, TRACKING, AND PROJECTING CHILDREN'S CLOTHING SIZES OVER TIME

(76) Inventors: Stormy Compean Sweitzer, Salt Lake City, UT (US); William John Swanepoel, Salt Lake City, UT (US)

Correspondence Address: BATEMAN IP LAW GROUP, P.O. BOX 1319, SALT LAKE CITY, UT, 84110, US

(21) Appl. No.: 12/244,743

(22) Filed: Oct. 2, 2008

Related U.S. Application Data
(60) Provisional application No. 60/978,045, filed on Oct. 5, 2007.

(51) Int. Cl. G06Q 30/00; G06F 17/30; G06Q 90/00

(52) U.S. Cl. 705/27; 705/26; 705/1

(57) ABSTRACT

The present invention relates to an automated system and method for determining the best brand and product-specific sizes of garments or footwear for a child based on the child's measurements and the measurement parameters associated with a specific brands' sizing structures. The present invention also allows for projecting changes in the child's garment or footwear size by brand and product type over time either by projecting the approximate date on which a child will outgrow their current size or by projecting a future size for some given date in time.

### RELATED APPLICATIONS

The present application claims the benefit of U.S. Provisional Application Ser. No. 60/978,045, filed Oct. 5, 2007, which is expressly incorporated herein by reference in its entirety.

### BACKGROUND OF THE INVENTION

1. The Field of the Invention

The present invention relates to a shopping aid for selecting clothing sizes. More specifically, the present invention relates to a system and method of determining, tracking and projecting children's clothing sizes as the child grows for the purpose of increased accuracy and convenience in children's apparel shopping, clothing size comparisons, gift giving or subscription-type clothing purchases.

2. State of the Art

Infants typically grow 10 inches within their first year and 5 in their second. Common times for growth spurts are during the first few days, around 7-10 days, 2-3 weeks, 4-6 weeks, 3 months, 4 months, 6 months and 9 months (more or less). Growth spurts don't stop after the first year—they may occur every few months during the toddler years and periodically thereafter throughout the teenage years.

Unlike adult sizing, children's clothing sizes often correspond to typical age-related growth spurts for the average child. For example, size “0-3 m” is intended to fit a 0 to 3 month old child of average height and weight. As has been documented by the National Centers for Health Statistics, though, the frequency of growth spurts and amount of growth that occurs in a given time period varies by child, making it difficult to for parents to use age-related children's clothing sizes as a strict guideline when shopping. In other words, age-related sizes may be inappropriate if a child grows more quickly or slowly than the average child for that age. As used herein, children or child typically refers to children between birth and about 18 years of age. This period of time represents the time of greatest growth for children and can be the most challenging for finding the appropriate clothing size for the child. As used herein, clothing may be used to refer to both apparel such as pants and shirt as well as shoes and the like.

The problem of children's rapid and variable growth is compounded by the ways that clothing manufacturers or Brands define their size coding or naming system and how they grade their clothing sizes. For example, a child that weighs 12 pounds and is 22′ in length, Brand A may use size code “Infant small,” Brand B size code “0-3mo,” and Brand C size code “3m.” The range of measurements that seemingly similar size codes correspond to may also vary from Brand to Brand. For example, Brand B's size code “0-3mo” may fit a baby up to 13 pounds and 23′ in length while Brand C's “3m” may fit a baby up to 12.5 pounds and 24′ in length.

As well, sizes become more specific to gender and girth, requiring parents to compare and contrast manufacturers' sizing parameters to determine the best size for their child. In the case of gender, a girl's size “12” might fit the average 12 year old girl, but grading parameters may vary from a boy's size “12.” In the case of girth a 12 year boy with a narrower waist than average might wear a size “12 slim” while a larger 12 year old boy might wear a “12 husky.” For this reason, it is not always easy for a consumer to know which size is most appropriate for their child nor should they rely on one size code from brand to brand.

Currently, retail spending for children's apparel is estimated to total over $35 billion annually, with approximately 10% of that total attributable to online sales. While online retailing has many advantages, a major disadvantage is that the item is not available for inspection. If a person is purchasing clothing, for example, it is difficult to determine if the item of clothing is the right size for a child, especially where the purchaser does not know the child's height and weight.

Most parents resolve these size and fit problems by trying clothing on their children at the store. Unfortunately, matching clothing sizes to a specific child is a particular problem for parents wanting to buy clothing for their child over the internet, or in any other situation where it is impossible to try the clothing on the baby or child, or where it would be easier to identify different brands' sizes before trying them on and rejecting them as ill-fitting.

If a child is not available for fitting, many consumers buy children's clothing at least one size larger than the recommended size for the child's age. This allows the child to “grow into” the clothing. However, if the clothing is too far off in size, the child may “grow into” her shorts in winter or her snowsuit in summer, reducing consumer satisfaction or resulting in returns. Neither result is desirable.

Sizing is also a problem for gift-givers wanting to buy appropriately-sized gifts. When a person is purchasing clothing as a gift, they may be hesitant to ask for the child's height and weight, as it might lessen the surprise of the gift. Manufacturers have tried to alleviate some of these problems by sizing children's clothing by age. While manufacturers may give body measurement and age guidelines to make it easier for persons to select clothing, the purchaser may not know the child's body measurement. As well, enough variation exists in children's growth patterns, to make it difficult to select the correct size based on age alone.

Online retailers have resorted to many different strategies to make it easier for consumers to purchase goods. Liberal return policies as well as product photographs and details aid the consumer in making purchasing decisions. Online retailers may also offer a generic size chart that provides general measurement guidelines for fit, including height, weight, and other standard measurements. They typically do not offer individualized size charts for each brand they carry—which may not conform to generally-accepted grading standards, nor do they offer size calculation services. As well, size charts do not help significantly if the purchaser does not know the child's height, weight or other relevant measurements. Concerns about fit, then, may result in reluctance to buy particular items from the internet and an increase in the number of product returns to retailers when the item is purchased but the size is wrong.

Returns present a financial burden for online retailers, as they are expensive and inconvenient for the retailer to process and may result in lost inventory. Returns also pose an emotional hurdle for customers, and can seriously impact customer satisfaction with a purchase.

Thus there is a need for increasing the accuracy of purchases of children's clothing. There is a need for a way to communicate more effectively the sizing information of the child to the purchasers.

Prior art patents have attempted to solve problems associated with determining an accurate fit for garments on a customer and storing this information for ease of use during shopping, though none have specifically addressed the dynamic nature of children's growth and its relationship to size changes over time.

U.S. Pat. No. 6,665,577 describes an automated system and method for predicting garment fit on a customer. The invention's specific purpose is tell a customer how well a garment will fit them by comparing the customers body measurements to a manufacturer's intended grading system and then calculating fit, thereby supporting garment selection and purchase in different retail environments. This invention relies on a current set of customer body measurements and does not have the ability to project changes in growth over time. The present invention addresses this problem by using public health data to determine a child's percentile growth, estimate a growth pattern, and project growth-related changes in apparel size.

U.S. Pat. No. 6,246,994 is designed to allow consumers to store information, relevant to their size or other concern, in a remote location that is easily accessible to the consumer when needed. The invention functions primarily as a secure data storage mechanism which a customer can access at the point of need, whether that need be a purchase or other event where personal information is needed. However, the '994 patent does not provide a methodology for helping the customer determine how the information they are storing corresponds to available sizes, product options, or other items and whether there is a match between them. The present invention facilitates size calculation and product identification based on customer data.

U.S. Pat. No. 6,311,403 provides a means for calculating men's apparel sizes based on a particular consumer's height and weight. The calculator determines typical body measurements (i.e., chest, waist, hip, inseam, neck, etc.) relative to height and weight using predetermined body measurement proportion relationships. Based on these measurements, the calculator suggests typical apparel size and measurement guidelines that correspond to them. Because this calculator relies on typical body proportions, rather than individual body measurements or proportions, sizing may not reflect the actual measurements of the person using the calculator. The present invention resolves this issue by relying on a child's actual measurements and using them as the foundation for estimating proportions as the child grows.

The goals of the present invention are to offer a method and system that addresses the drawbacks of prior art and to calculate age, gender, and measurement-appropriate clothing sizes for children, while incorporating the unique predictability of children's growth patterns to project size changes over time.

### SUMMARY OF THE INVENTION

The present invention overcomes problems in determining a specific brand's or manufacturer's apparel or footwear size for a child (again typically a child between birth and 18 years old) when the child is not present to try items on. It provides consumers with a tool that helps them find the most appropriate size in a brand or brands' clothing, shoes, or hats for their child at any given point in time.

According to one aspect, the invention allows a consumer to enter their child's birth date, gender, a plurality of body measurements taken by a conventional measuring tape or other means of measuring body attributes into the system and receive brand and product-specific sizes that are most likely to fit their child. Additionally, consumers may record a child's body measurements in an account system, where they may also store shopping preferences such as favorite colors, brands, retailers, and pricing, that further support their shopping goals.

According to another aspect, the invention can also project the best size of apparel or footwear, in the absence of current measurement data, based on the child's estimated growth trend using measurement information that has been supplied in the past. Specifically, the invention compares a child's actual or estimated body measurements to individual brand's suggested size parameters (the upper and lower limits for each body measurement for a given size category—i.e., baby, toddler, or child—and product type) to determine the most appropriate size of clothing for a child now or in the near future.

According to another aspect of the invention, the system and method may be used to provide accurate children's apparel and footwear sizes by brand to a parent or gift-giver. The system can also maintain a database of child-specific accounts to help a parent track their child's or children's' measurements and clothing size information over time. It may also suggest sizes based on a child's projected growth trajectory.

These and other aspects, features and advantages of the present invention will become better understood through the following description and accompanying drawings.

### BRIEF DESCRIPTION OF THE DRAWINGS

Various embodiments of the present invention are shown and described in reference to the numbered drawings wherein:

FIG. 1 shows a basic flow diagram of a size calculation process of the present invention;

FIG. 2 illustrates the data sources typically used by the present invention;

FIG. 3 shows a sample process flow diagram illustrating the input of information for the size calculation process of the present information;

FIG. 4 shows a table of priority fit measurements by product type as may be used in the size calculation process of the present invention;

FIG. 5a shows a basic flow diagram illustrating a high-level overview of a simplified size projection process;

FIG. 5b shows a basic flow diagram illustrating a high-level overview of a full measurement size projection process; and

FIG. 6 shows a sample clinical growth chart.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

The present invention provides a system and methodology for calculating the brand-specific size or sizes of apparel or footwear that are most likely to fit a child given their current body measurements, age, and gender. Additionally, the invention tracks child-specific body measurements entered by a consumer over time and uses population-based growth trends, available from sources such as the National Center for Health Statistics and World Health Organization, to estimate growth patterns and project changes in apparel and footwear sizes for the child at future dates in time. It is appreciated that the system will provide the service for a plurality of children.

In other words, using data such as a child's body measurements, a consumer's brand and product type preferences, and the measurement parameters associated with sizes for individual brands, as well as a method of prioritizing key body measurements by product type, the system calculates the best brand-specific size or sizes—if more than one is appropriate—for a child. It also provides the consumer with size and fit information. The information provided to a consumer can include brand-specific sizes, how close the child's measurements are to the upper limit of a preferred brand's size parameters for a given body dimension, whether it might be preferable to purchase the next size up in a product, suggestions of other brands' sizes that may be relevant, factors—such as fabric type and shrinkage—that modify how an item fits, and other details that may aid a consumer in making an informed apparel and footwear purchasing decision.

Additionally, the system will estimate a child's growth trajectory and project changes in their apparel and footwear sizes by brand over time. It does this by finding the upper limits of the body measurements associated with the brand-specific size or sizes that a child currently wears, and then projecting when a child will reach those limits based on their estimated growth pattern. Growth patterns are determined by the child's current growth percentile curves for height and weight according to clinical child growth tables or charts which track percentiles by age. Where additional measurement inputs are needed to calculate a size, the system determines a height to body measurement ratio for each of the remaining body measurements and then uses that ratio to estimate future body measurements relative to the projected height. For each projected size change by body measurement, the system determines the expected date of change and uses the earliest projected date change to notify a consumer that their child will soon outgrow their clothing.

I. Key Terms

The following terms and symbols are used herein to more fully describe the system and method. Some terms are commonly-used apparel industry terms; others are specific to the present invention.

Body Measurements: Body measurements are physiological indicators used to compare individual growth, contrast a variety of individuals, or compare an individual to apparel Size Parameters to determine best fit. Typical measurements used to determine clothing size include, but are not limited to chest, waist, hip, inseam, height, and weight. Head circumference, foot length and width, and other more specific body measurements may also be used to determine accurate sizing.

Brand: Brand refers to a label or name associated with apparel or footwear products that are identified by a specific logo, look, grading system, and marketing approach. As pattern grading is typically Brand-specific, Brand is used as the basis for body measurement requirements needed to carry out size calculation. For purposes of this invention, product manufacturers are also assumed to use specific grading systems and are hereafter included in the term Brand.

Child-type Category: The general categories of infant, toddler, and child used in the Size Calculation Process.

Ease: The size of a garment minus the size of the body wearing it at given body dimensions. Brands design their products with a specific ease in mind; the intended ease for a given size code is the size of a garment minus the size of the model, along certain body dimensions, that the size code is intended to fit.

Fabric Type: Characteristics that may affect a garment's fit or shrinkage when washed.

Grading: When referring to clothing and footwear, grading is a system used to scale a pattern to different sizes by making incremental adjustments at key points in the pattern. While industry standards exist, most brands and manufacturers use their own grading system, thereby impacting the size parameters for their products.

Growth Pattern: Growth patterns are actual or estimated trajectories of a child's past or future, respectively, rate of growth.

Growth Percentile: Growth percentiles rank the position of a child by indicating what percent of that child's peers the individual would equal or exceed in terms of their height, weight, or other dimension. For example, a 5-year-old girl whose weight is at the 25th percentile, weighs the same as or more than 25 percent of other 5-year-old girls, and weighs less than 75 percent of 5-year-old girls whose measurements were used to determine growth percentiles.

Growth Percentile Curve: Growth Percentile Curves illustrate the distribution of selected body measurements in U.S. children. For our purposes, height, weight, and head circumference are most relevant, but any body measurement for which there is sufficient population data can be distributed in this manner.

Growth Spurt: A period of rapid growth, typically experienced in early childhood and adolescence.

Measurement Chart: A chart used to outline the range of body measurements that a given clothing or footwear size is expected to fit. These charts are also referred to as Size Charts and are often specific to a manufacturer or brand's pattern grading practices.

Measurement Units: Refers to the unit of measurement used to calculate a size code. These measurements may be supplied in US or Imperial customary units or Metric units of measurement, depending on the consumer's preference. The units of measurement commonly used in the size calculation and projection processes include feet/inches and centimeters for height, and pounds and kilograms for weight.

Product Type: Product Type refers to one of several major categories of apparel or footwear that are associated with specific body measurements. In other words, each Product Type is intended as a proxy for a set of body measurement requirements. The Product Types used include Tops, Bottoms, Outfits, Shoes, Hats, Belts, and Universal Apparel. Within each Product Type category there are several sub-categories of apparel that are more typically used in shopping, i.e. Tops encompasses sweaters, t-shirts, blouses, etc.

Projected Growth: Refers to the estimated growth of a child along the percentile curve at which the child has been ranked. For example, a child that falls within the 5th percentile is expected to grow a particular amount along that percentile curve each month. As children experience unpredictable growth spurts, projected growth estimates are imprecise.

Retailer: A purveyor of products, including apparel and footwear. Retailers carry a product portfolio that includes a variety of externally-produced and private label (or in-house) Brands. For purposes of the invention, the term Retailer may refer to either a user of the size calculation services or to a variable associated with a list of Brands and product types.

Size Code: Refers to the name for a given size of garment or footwear used by a manufacturer or Brand within their overall size nomenclature. For example, a Brand may use size code “Infant small” or “0-3m” to refer to a clothing item intended to fit a child that is less than 13 pounds and less than 21 inches in length. A size code may also refer to one of the many codes within the standardized size nomenclature employed by the apparel and footwear industries.

Size Parameters: Refers to the upper and lower body measurement limits for which a garment or footwear size code has been designed to fit. For example, the Size Parameters for a toddler's size 4T may be 34 to 38 pounds and 38 to 41 inches. The Size Parameters for a size take a brand or manufacturer's intended ease for the garment into account. May also be referred to as body measurement parameters. Widget: A small software program usually designed to one very specific thing. It can exist on a website, on a user's desktop, as a part of an operating system, or other electronic environment. On social networking sites, for example, widgets are used by members to personalize their profile pages.

The following additional factors may also be employed in the Size Projection Process:

| | |
|---|---|
| X | X is a body measurement variable, and may be substituted with Height, Weight, or |
| | any other body measurement deemed necessary for apparel or footwear size |
| | determination |
| P | Percentile growth curve within which a child's measurements fall by age and gender |
| LL | Lower limit, the lowest number in a range of numbers. |
| UL | Upper limit, the highest number in a range of numbers. |
| PUL | Upper limit for percentile growth curve measurement range, also known as |
| | percentile upper limit. |
| cX | A current body measurement for the child. |
| cXPUL | The upper limit for the Percentile Growth Curve measurement range for a child's |
| | body measurement, typically Height or Weight, given the child's current age in |
| | months |
| #XPUL | The percentile upper limit for a child's body measurement, typically Height or |
| | Weight, in some given month in the future. |
| cDifX | Difference between cXPUL and cX. Typically performed with Height and Weight |
| | body measurements, resulting in cDifH and CDifW, respectively |
| eDifX | The gap between the Height or Weight the child should be at relative to today's |
| | Height or Weight (eXPUL − cDifX) and the expected Height or Weight at the time of |
| | the projected size change. For each body measurement's estimated month of size |
| | change (e#X), (e#XPUL − cDifX) − eHX = eDifX |
| eX | Estimated body measurement for a child at some given point in time |
| eHX | Estimated Height or Weight for a child at some given point, or estimated height |
| | relative to another body measurement. For Height and Weight, bXPUL = eHX, |
| | where X = Height or Weight respectively. For other body measurements, bXPUL * |
| | rHX = eHX, where X = any other body measurement. |
| InX | The amount a child is expected to grow within the month of expected size change |
| | (e#X) up to and including the target for a given body measurement (eHX). It is |
| | calculated in the following manner: eHX − (e#-1XPUL − cDifH) = InX. InHeight = |
| | inches, InWeight = pounds. |
| rHX | Height-to-body-measurement ratio, based on the most current actual measurements |
| | for a child. |
| bXUL | The upper limit for a body measurement in the child's current size for a given brand |
| | (i.e., GapKids Boy's Size 8plus has a bChestUL of 30″) |
| DifX | The difference between #XPUL and X, where DifX for Height is identified as DifH |
| | and DifX for Weight is identified as DifW. |
| e#X | The month in which size change is expected to occur relative to a given body |
| | measurement X, where # is a child's age in months. The e#X is that in which |
| | #HeightPUL − cDifH ≧ eHX for a given body measurement. |
| e#XDay | The number of days into the estimated month that size change is expected to occur. |
| | Calculated as: XMult * 30 = e#XDay |
| e#XPUL | The percentile upper limit for the month in which size change is expected to occur, |
| | where # is equal to the month of expected change and X is equal to a given body |
| | measurement. |
| e#-1XPUL | The percentile upper limit for the month prior to the month in which size change is |
| | expected to occur, e.g., if e#XPUL is 95ChestPUL, then e#-1XPUL is |
| | 94ChestPUL. |
| XPULDif | The difference between the e#XPUL for the month in which a size change is |
| | expected to occur and the previous month's e#-1XPUL for a given body |
| | measurement |
| XMult | The day multiplier for a given body measurement used to determine the number of |
| | days into a month a size change is expected to occur, calculated as: InX/XPULDif = |
| | XMult |

II. Apparel and Footwear Size Calculation

Each Brand of apparel or footwear creates clothing styles and uses a size grading system that reflects the look and feel that they want to convey to their customers. As such, Product Size Parameters typically vary from Brand to Brand, as well as within Brands that produce multiple styles of clothing.

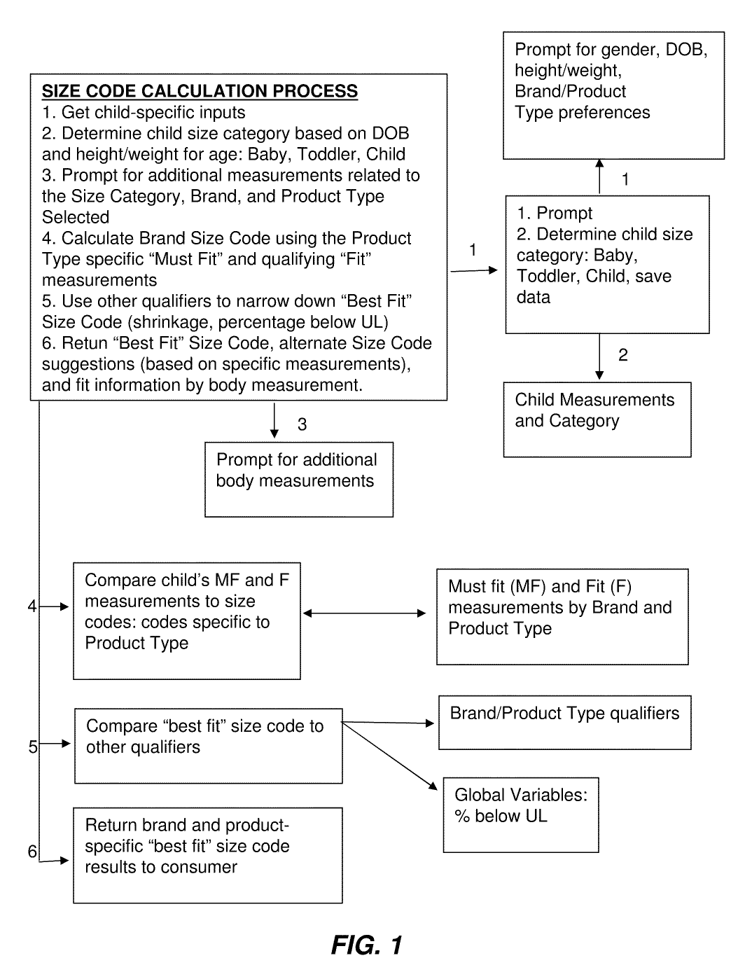

The Size Calculation Process of the system, shown in FIG. 1, consists of a method for calculating or retrieving the best Brand-specific size or sizes of clothing for a child based on multiple inputs. In its most basic sense, the Process compares the child-specific inputs with Brand-specific size parameters and then prioritizes certain measurements to determine which size or sizes are likely to result in the best fit for the child. This information is then presented to the consumer to assist them in purchasing the best size of apparel or footwear for a given child.

a. Child-Specific Inputs

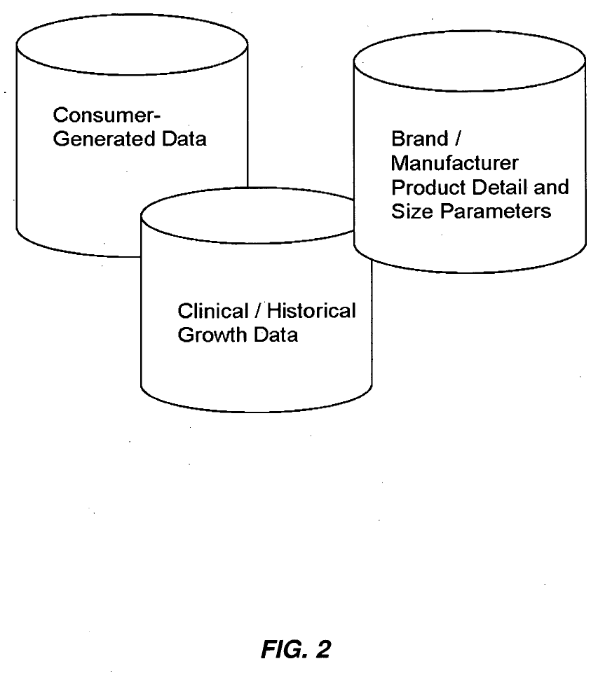

The invention requires data from a number of sources, including, as shown in FIG. 2, consumer generated data related to the child or children for which apparel and footwear sizes are being calculated. Child-specific inputs are acquired directly from a consumer through a digital interface/electronic communication device.

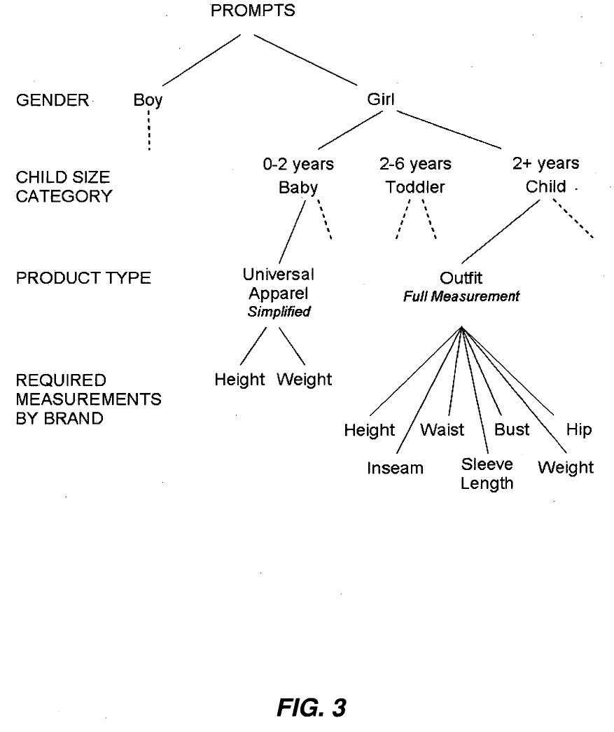

1. As shown in FIG. 3, consumers will be asked to provide inputs such as gender and date of birth, to select brand and product type preferences, but also to determine several key body measurements for their child. Which inputs are requested, the order in which they are requested, and how the input information is entered into the system will vary depending on how and where the consumer interacts with the Process.

Size calculation can be initiated on a retailer's web site, in which case product-specific details, such as retailer, Brand, product type, and gender category may be known or easily selected and only product type-specific body measurement inputs are required. Size calculation can be initiated through a widget or independent application on a third party website, in which case all child, product and Brand-related inputs are required. Or, size calculation can be initiated through a site created specifically to conduct size calculation and product recommendations, in which case child and Brand-specific inputs will vary based on how the consumer interacts with the site, i.e. calculates a Brand-specific size for reference, tracks their child's growth and size changes over time, or shops for a product and then calculates the best size, etc. It is appreciated that other interaction types and input requirements may be possible.

In other words, the system will prompt the consumer to supply only those body measurements that are needed to calculate the best size code for their child given the Brand or Brands they prefer, the product type or types they might select, and/or the child's age and gender.

In one variation, a consumer is prompted for body measurements related to the Brand selected. As each Brand carries specific product types and uses a specific set of Size Parameters, it is possible to request only those body measurements that are relevant to a Brand. Brand A, for example, may only make apparel for boys aged 2 to 7 and require height and weight measurements only. Brand M, on the other hand, may make apparel, shoes, and hats for pre-teen girls and will require a broader set of body measurements to determine the best size code for each of the product types they carry.

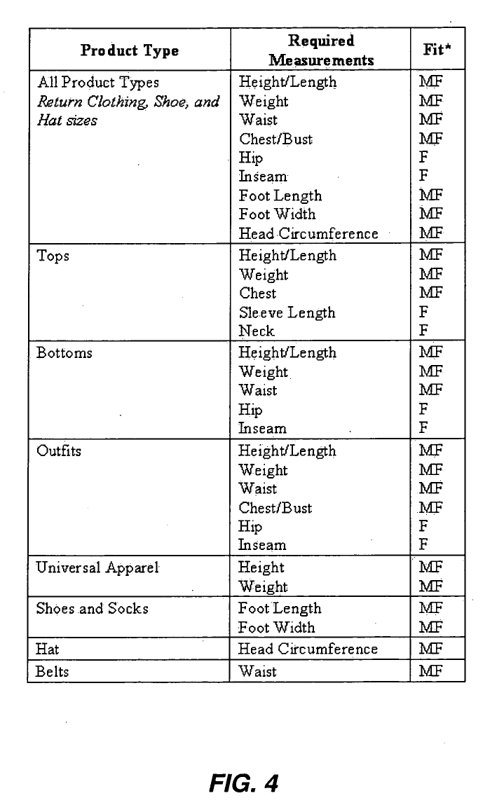

In another variation, a consumer is prompted for the body measurements needed to identify the best size for a given Product Type. These measurements may be supplied in US or Imperial customary units or Metric units of measurement, depending on the consumer's preference. As is seen in FIG. 4, the system uses major Product Types to prompt for body measurements: Tops, bottoms, outfits, universal apparel, shoes, belts, and hats. Each Product Type is associated with specific body measurements. For example, the measurements needed to calculate pant size differ from the body measurements needed to calculate shoe size. It should be noted that, in order to reduce system processing time, the major product types encompass sub-categories of apparel and footwear that reflect common shopping options, and which utilize the same or fewer measurements to determine correct size.

FIG. 4 also shows that the body measurements requested may be modified by the gender and age of a given child. Gender may be used to identify body measurements that pertain to a single gender—for example, chest versus bust, or for product types, such as dresses and skirts, which are gender-specific. Age may also be used to delimit the number of body measurements requested in cases where the body measurements needed to determine size vary by age. For example, for children younger than 2 years of age, height and weight may be the only measurements needed to calculate size; whereas hip, chest, and waist measurements may be needed in order to calculate size code(s) for an older child.

To ensure that measurements are as accurate as possible, measurement guidelines will be supplied to the consumer to illustrate where and how to correctly obtain each body measurement. Body measurements may be taken by using a flexible cloth or plastic tape measure. Measurements may also be taken using other measurement devices or means that are available to the consumer, such as by using an electronic tape measure or body scanning device, or by requesting assistance from a tailor or children's clothing specialist, for example. These physical measurements will be entered into an electronic interface either by the consumer or some other person, such as a gift-giver or assistant.

In instances when a consumer does not have ready access to any of a child's measurements except height and weight, the system may estimate non-supplied body measurements or base the clothing size recommendations based solely off of height and weight. In one variation, the system will use the child's age, gender, height and weight to identify the child's weight-for-stature growth percentile and estimate other body measurements that correspond to that percentile according to population-based childhood health and growth data. In another variation, the system may prompt the consumer to respond to a series of simple questions that can help the system estimate measurements. These questions might include questions that assess how clothing typically fits the child, such as, for example, whether long sleeved shirts are typically too short, too long, or just right. In another variation, the system may prompt a consumer to supply the name of a brand that currently fits their child well and then use the size parameters for the child's current size in that brand to estimate the child's measurements, i.e., if FitKids brand uses a 15′ sleeve length and FitKids brand fits the child perfectly in the consumer's mind, then, a 15′ arm length may be used to approximate fit in other brands.

Measurements provided by the consumer can either be entered into the system once for a quick size calculation, or they can be stored (by unique-user IP tracking, use of internet cookies, or a user-created account) for later reference.

b. Calculating Apparel and Footwear Sizes

1. As specified above, the first step in the Size Calculation Process requires that a number of basic inputs be entered into the system. The inputs include a child's birth date, gender, and an array of body measurements (including, but not limited to height, weight, chest/bust, waist, hip/seat, inseam, foot length, foot width, head circumference). Brand and product type preferences will also be requested, but may default to a specific product type, all possible product types in the system, or only those product types carried by the brands selected.

2. Using the child's date of birth, the system determines which size category the child falls within. If the child is less than 24 months, he or she falls into the Baby size category. If the child is greater than 72 months, he or she falls into the Child size category. If the child is greater than 24 months and younger than 72 months, where industry Toddler and Child sizing systems often overlap, the invention may prompt the consumer to choose between Toddler sizing, Child sizing, or Both, as a means of calculating size. The system may also provide the consumer with the applicable size in either category, thereby reducing the number of questions a consumer must respond to and provide the consumer with more options. Since the overlap between Toddler and Child sizing varies by brand (i.e., 2/2T-5/5T versus 4/4T-7/7T), the system may search either or both categories in cases where both categories are offered by a brand and where the child's age and measurements specifically overlap both categories.

As some children grow more quickly or slowly than others, children under 24 months of age whose height and weight measurements are greater than those of the typical 24 month old child of their same gender will be categorized as greater than 24 months and the system will search for appropriate Toddler-sized apparel and/or footwear; the consumer will be prompted for any additional measurements required by the Brands they have selected. Children older than 24 months of age whose height and weight measurements are less than those of the typical 24 month old child will fall into the Baby size category and no further information will be requested of them. Children whose height and weight measurements are greater than the typical 72 month old child of their same gender are automatically categorized as Child. In these cases a “typical” child is one that falls along the 50th percentile growth curve for height for age and weight for age for the child's gender based on clinical growth data collected by the Centers for Disease Control, the World Health Organization, or some other reputable source.

3. Using the child's size category and the product types selected, the system will prompt the consumer to enter any additional body measurements required to calculate the correct size code for each brand they prefer.

If the child falls into the Baby size category, the previously entered height and weight measurement inputs are sufficient and apparel size calculation proceeds; the consumer will only be prompted for additional measurements if they select hat or shoe product types. If the child falls into the Toddler or Child size category for a brand, the system will use the brand and product type or types selected by the consumer to prompt the consumer for any additional body measurements.

As mentioned, if a child is entered into the system as a baby, only height and weight measurements are required. Using these inputs, the system can estimate when to ask for additional size information in one of three ways. Based on the child's date of birth, the system will recognize when the child is nearing the age point (24 months) where additional measurements may be necessary for the selected brands. Based on the child's measurements, the system can project the child's growth trajectory and identify the point at which a) the child will outgrow a given size, moving into a size that requires additional measurements or b) the child is larger than the typical child of 24 months (the point at which more measurements may be necessary). This identification can trigger a notification to the consumer prompting them to supply additional measurements if needed to calculate a child's size.

As has been noted, the system takes into account that certain measurements may be gender specific and can prompt the consumer for gender-specific measurements based on the gender input they have supplied to the system.

In cases where a consumer does not have all of a child's body measurements available, it may be possible to calculate a size by using the child's height and weight only. Alternatively, the system may determine a child's percentile growth for height and weight by age and then estimate other needed body measurements from population-based data from clinical sources where available. A message indicating that the “best fit” size codes are based on estimates of key body measurements can be provided to the consumer, notifying them that more accurate size calculation may be possible if additional body measurement inputs are supplied.

4. Once the child's body measurements have been specified, the system will search records of selected brands' sizing parameters by product type to identify the best size code for the child. The system may also use the child's inputs to search the records of all brands in order to identify size codes for a child in brands the consumer may not be familiar with. In other words, one element of the invention compares the child's age, gender, size category, and body measurements to brand-specific size parameters and retrieves the most appropriate size code(s) for the child in selected brands available in the system.

The System identifies all Brand Size Codes within which the child's measurements fit. The Brand Size Codes are defined by Product Type and include range values or Size Parameters for the applicable body measurements. For example, height, weight, chest, and sleeve length measurements may be needed to identify a specific size code for the product type of Tops, and each Size Code has upper and lower Size Parameters that delimit the height, weight, chest, and sleeve length values that the Size Code is designed to fit.

5. Each size code that is found to be a possible fit is then assessed by the system, giving priority to size codes that meet certain requirements. While all body measurements are important, certain measurements are more important than others in terms of how products fit, how they look, and how adaptable they are to a child's growth. For each Product Type, several body measurements are needed in order to determine if a size will fit a child; these measurements are based on the most commonly used measurements for apparel and footwear product categories among children's brands. The Fit column in FIG. 4 identifies required (Must Fit=MF) and optional (Fit=F) body measurements.

MF measurements are those that are used relatively consistently across brands to determine fit and are required in order to calculate a child's size code accurately. Each product type has a minimum of 2 MF measurements, except for hat and belt products, which require one measurement only. Weight is considered a MF measurement for many product types, but will only be required for brands that use weight as a body dimension in their size code structure. F measurements are considered optional as they are not used consistently across brands as guidelines for fit; as well, it is possible to calculate a size code for a child with reasonable accuracy in cases where the consumer may not have these measurements readily available. F measurements, when used by a brand and data is available from the consumer, are used to further qualify a size code as appropriate for a child. Body measurement prioritization may be adjusted at a brand, product, or consumer level if needed to provide the most accurate fit results, e.g., a brand may cut their bottom-type products particularly long, making inseam more important, or a parent may determine that waist and hip measurements are of greater priority than height for their child.

Using the child's inputs, the Process identifies which Brand-specific Size Code Parameters the child's MF body measurements fall into. If the child's MF body measurements fall within only one Size Code, the system identifies that Size Code as the “best fit” for the child in question. F measurements are then used to further qualify this size code. If any of the child's F measurements are greater than the upper limit of Size Parameters for the “best fit” Size Code, the system still return the “best fit” Size Code along with information that explains why it may not be a perfect fit, such as which measurements do not fit within that Size Code.

It is possible for body measurements to fall within multiple Size Codes because of overlapping measurement ranges in cases of Toddler and Regular size children's apparel, Slim, Regular and Plus-sized children's apparel, or regular, narrow, and wide shoes. While using MF measurements is intended to prevent this from occurring, in the event a child's MF body measurements do fall within multiple Size Codes, the system will flag all possible “best fit” Size Codes and then use F measurements to better qualify each size code, narrowing down the number of size codes that are relevant, or, in some cases, identifying other size codes that may be more appropriate, such as larger sizes or different cuts (e.g. toddler versus regular cut).

The system also takes into consideration that children grow quickly. A size code may only be considered appropriate if all body measurements are some percentage below the upper limit of the size parameter for each body measurement used for a product's size code. For example, if a child's waist measurement is within 5%, or some other pre-determined percentage deemed appropriate, of the upper limit of the size parameter for Bottom's waist for a brand, the next larger size code may be suggested so that the garment or footwear fits comfortably and the child does not grow out of the clothing too quickly. The percentage used may vary by body measurement and by whether the measurement is an MF or F type body measurement.

The system will repeat this process for each Brand and product type for which a consumer would like to find their child's size code(s).

c. Presenting Current Size Information

Current size information can be presented in a variety of ways including in a size calculation screen on the internet or at a kiosk, through an email notification, in an online user account interface, through a size calculation module or widget on a retail or social-networking website, a consumer's mobile device, or in any other digital interface that may be available to the consumer.

The system will return to the consumer the Brand-specific Size Code for each requested Product Type that is found to meet the calculation requirements, if one is available. Where a child's body measurements fall outside of a brand's available size code parameters, no size code will be suggested to the consumer; instead the consumer will receive a message that no acceptable size code could be found in a brand and a recommendation that they search other brands that are available in the system.

Additionally, the system will provide any messages that would help support a decision to purchase a size other than the suggested size code. Such messages may include any other size codes that are near-matches with a child's body measurements, that a child is likely to outgrow a size code quickly and a larger size is suggested, or if a garment or footwear item will be loose, tight, long, short, etc. given the child's body measurements and the brand's size parameters for a given size code. Other messages may include any other information that the system can calculate, given the available data, which is relevant to a consumer's purchasing decision process as it relates to a child's apparel and footwear size. These messages are deemed useful insofar as some consumers prefer to purchase larger than needed sizes, to purchase from a specific brand, or to purchase clothing that fits in a particular way, e.g., preferring that pants fit a child's waist perfectly even if they are too short or too long.

Product suggestions that match the child's brand-specific size code(s) may also be presented, enabling a consumer to easily identify items that would be appropriate for the child. Such products could be linked to retailers' websites where the consumer may purchase the products, to a product-based search engine, or to a system-driven website where the products and others like them could be found and/or purchased.

Child size information can also be shared with family and friends through a registry or wish list type system to support gift purchases

d. Examples

A consumer enters a system-driven website and decides to create an account for their child. They establish a user name, such as a name or alias, and password with which to access the account, provide a means of contact, such as an email address, and create a profile for a child. For the profile, the consumer will enter into the system the child's name or alias, date of birth, gender, height and weight. They will also select multiple brands and product types from a list for which they would like to know their child's size. The system will use this information to prompt the consumer for any additional information needed to calculate size accurately.

In this case, the child is female, was born on Dec. 1, 2006, is 35′ tall, and weighs 29 pounds. This information is entered on Jul. 15, 2008 and the date and current measurements are stored by the system for future use. The consumer has selected TotTog's brand clothing as one of their preferred brands and selected the default “All Product Types” as the basis for size calculation. TotTog's brand makes apparel products only and uses a “Universal Apparel” sizing approach, meaning that they use the same measurements to determine fit for all clothing product types; height and weight are the required measurements. These measurements have already been entered. Based on the child's age and body measurements, the system also determines that the child falls within the “Toddler” child size category.

The system searches the TotTog's Toddler size code parameters for the size code(s) within which the child's MF measurements for Universal Apparel fall. The system identifies a single size code—Toddler 2T. The relevant size code parameters are as follows: Height 34.5-36.5′, Weight 29-31 pounds.

This size code information is returned to the consumer. The size code information is stored for the child in the consumer's account for easy reference and will be used as the basis for projecting the date when the child is expected to grow out of this size code. The child's current measurements will also be used to help project size change and in calculating an estimated size code for the child's projected body measurements if the child's measurements are not updated.

In a second example, a consumer shops on a participating retailer's website, finds a specific item that they would like to purchase for their child, and clicks on a “Size Information” type hyperlink or button on the product page. The product is a girl's blouse made by the AllKids brand of children's apparel. This information is used to satisfy the Size Calculation Process requirements of gender (Female), child size category (Child), brand (AllKids), and product type (Tops).

AllKids uses height, weight, bust and sleeve length measurements as guidelines for fit; neck measurements are not used. The consumer is then directed to enter these measurements for the intended child into the system and to click on a “calculate” or “enter” type button on the system interface.

In this case, the child's measurements are as follows: Height 53′, Weight 67.5 pounds, Bust 27.5, sleeve length not known. The system searches the AllKids size code parameters for the size code(s) within which the child's MF measurements for Tops products fall. The system identifies a single size code—Girl's Medium. The relevant size code parameters are as follows: Height 52-54′, Weight 64-72 pounds, Chest 27-28′, Sleeve length 24.5′. The child's chest measurement, an F measurement, is used to further qualify the size as appropriate for the child. Once it is determined that the size code is a “best fit”, the size code is returned to the consumer to help them purchase the girl's blouse in the appropriate size.

No data is stored unless the retailer's site uses cookies or unique IP address to identify a consumer and the consumer has enabled cookies on the computer they use to enter the child's measurement information into the system.

III. Size Change Projection

a. Projecting Changes in Apparel and Footwear Sizes

The Size Change Projection Process projects future changes in a child's apparel or footwear size. In one variation, it projects the date on which a child is expected to outgrow their current size code(s) for a given Brand based on their current age, estimated growth trend, and the Brand's Size Parameters. The Size Change Projection Process draws on the same child-specific inputs as the Size Calculation Process, but compares them to clinical growth data in order to project the child's growth and compare it to apparel and footwear size code parameters to determine size change. In another variation, the Process projects the size(s) that a child is expected to wear at some given point in the future.

In other words, the system uses clinical growth data to determine the child's expected growth pattern for height and weight, finds height to body measurement ratios for all remaining measurements, and then projects the point at which the child will reach the size parameter upper limit for each body measurement associated with the child's current size code in a brand. These points in time are used to determine the order in which a child will outgrow certain dimensions of a product, and to calculate an approximate date upon which the size change associated with each measurement will occur. This information is also useful in estimating a child's current size prior to (or in the absence of) a consumer updating actual body measurement information for the child.

Growth projections in the absence of actual data updates can, theoretically, occur indefinitely throughout childhood without input of actual data by the consumer. While it is possible that this data will not reflect the child's actual growth pattern, it does allow the system to estimate the child's height and weight at a given point in time and calculate the corresponding size code(s); such estimates may be useful to consumers interested in assessing their child's growth potential, purchasing larger garments or footwear today for some future date, determining the frequency with which they will need to purchase items for a child, or some other objective.

The following process represents one method of calculating projected size changes for a child. Stating this process explicitly does not exclude other possible calculations arriving at similar conclusions. For example, it is assumed that Size Change Projection will occur subsequent to an initial size calculation. But, it may also be assumed that Size Change Projection may be followed by size calculation based on the projected body measurements for a child. Other variations and combinations of projection and calculation processes may be possible.

1. The Process first requires a plurality of child-specific inputs including, date of birth, gender, body measurements (will include all body measurements monitored by system), preferred brands, and date of measurement entry.

Child-specific inputs are initially collected at the time when a consumer first opts to create an account. For purposes of accurately tracking a child's growth, the System may be programmed to notify consumers within their account pages or by email, for example, to update a child's body measurements at certain intervals based on typical child growth spurts, at a frequency requested by the consumer, prior to a projected change in size, or some other frequency deemed necessary for the system to accurately track and trend a child's growth over time and to support size projection operations.

Each time a consumer updates a child's body measurements, the discrete measurement entries and the date that the measurements were taken are captured and stored. It cannot be assumed that the entry date is the same as the date the measurements were taken. It may be necessary to prompt the consumer to identify if the measurements were taken “today” (automatic date stamp occurs) or “some prior date” (in which case they are asked to enter the measurement date manually).

Once child-specific inputs are collected, the Size Change Projection Process employs several steps to project the approximate date on which the child is expected to outgrow their current brand-specific size code(s).

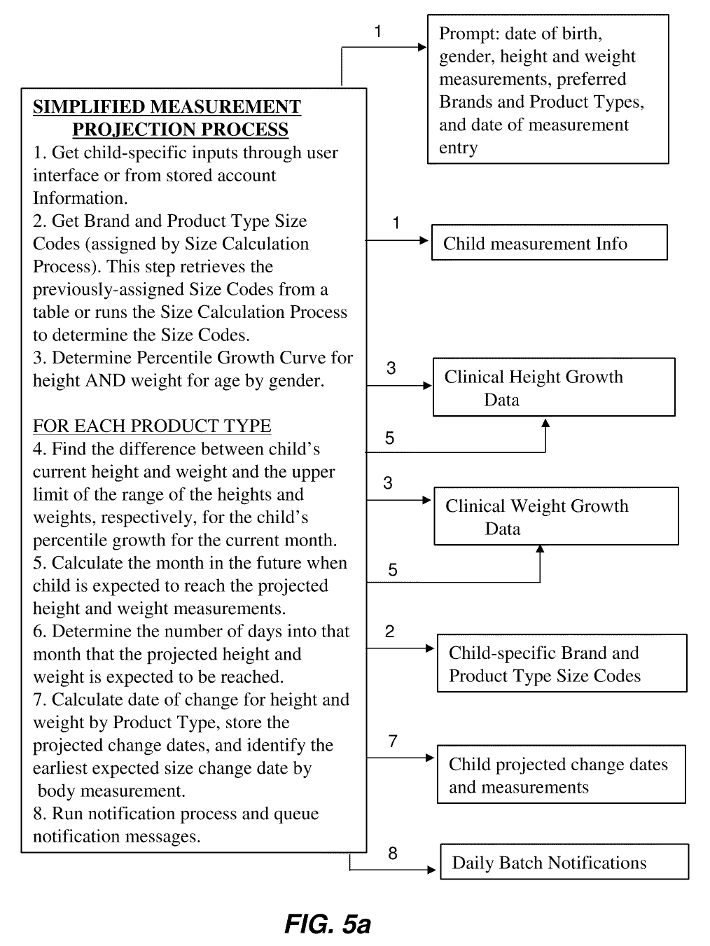

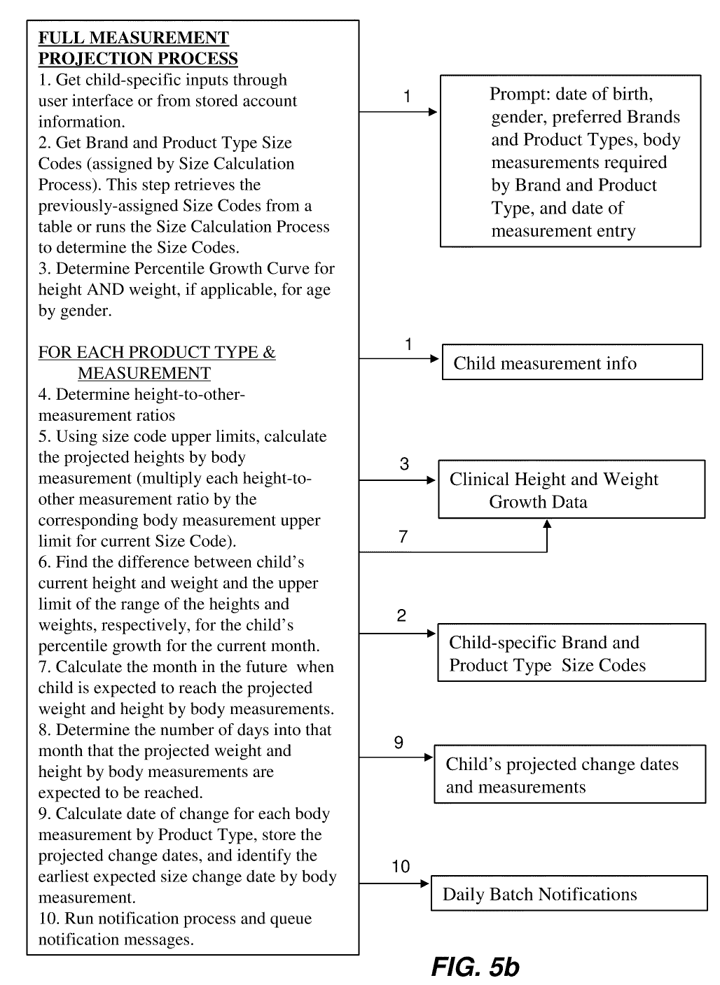

2. The child-specific inputs are used, first of all, to determine whether a full measurement or a simplified projection process is used. For the Simplified Size Projection Process (FIG. 5a), height and weight measurements are sufficient to project growth and size changes; this is typically the case for infant and some toddler apparel, but may also be the case with children's apparel. The Full Measurement Size Projection (FIG. 5b) is used in cases where a brand or product type relies on additional body measurements to determine accurate size code(s) for a child; this is the case with footwear, headwear, and often with children's apparel. If Full Measurement Size Projection is used, additional body measurements, such as chest, waist, hip, inseam, sleeve length, but other body measurements used by a brand or manufacturer to help determine fit will also be used in the projection process. As there is no hard and fast rule for assigning body measurements by age, the system may rely on brand-specific body measurement requirements to determine which projection process to use.

The system uses the child's gender, age, and most current height and weight body measurements to determine the relevant Percentile Growth Curves for the child.

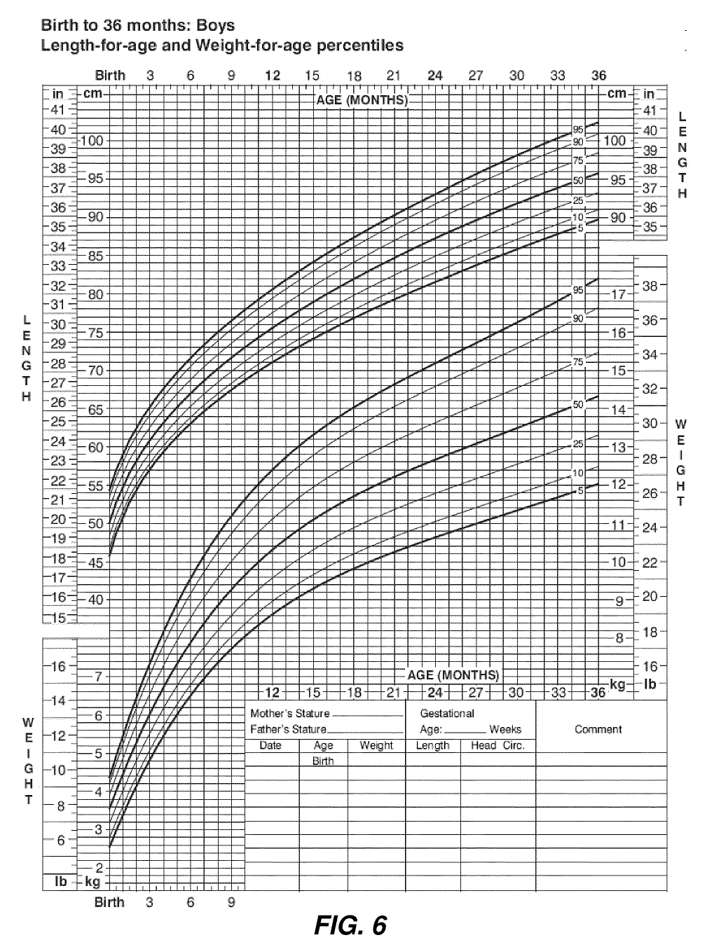

In one variation, the system finds the Growth Percentile Curve by comparing the child-specific inputs to representative growth data from clinical sources for infants, children, and adolescents, such as from the Centers for Disease Control or World Health Organization, to determine the child's percentile growth ranking relative to other children of their same age and gender. As seen in FIG. 6, clinical growth data is typically portrayed using several standard growth curves, including 3, 5, 10, 25, 50, 75, 90, 95, and 97 percent. Each point on a growth curve is defined by gender, one or more specific body measurements, and an age in months. In other words, a male child that is 3 years and 2 months old and weighs 33 pounds falls within the 75th percentile for weight for male children of his age. The 75th percentile growth curve can then be used as the basis for calculating the expected trajectory of the child's weight gain over time.

In another variation of this step, a child's growth pattern may be calculated more granularly by projecting a trend line based on a series of available actual body measurement inputs supplied to the system for that child. To aid in creating such a trend line, a consumer may enter several past sizing information events, such as those taken during recent doctor's appointments or documented in their personal records of the child's growth. The system may also calculate a precise percentile growth curve, e.g., the 28th or 63rd percentile, along which the child's height or weight falls using the same or a similar methodology as that employed by health authorities to calculate standardized growth curves.

Given the availability and standardization of population-based child growth data across height, weight, and infant head circumference variables, this step may be performed most accurately for these body measurements. But, projection of growth curves for other body measurements can occur in any case where there is sufficient aggregate, population-based data to create a standardized growth curve.

3. Growth percentile data is used to project height and weight body measurements into the future. In the absence of growth percentile data, growth in all other body measurements is projected in terms of height. For Full Measurement Size Projection, the system will calculate height-to-body-measurement ratios, identified as rHX, for the child using the child's current body measurements and store them for later use. As Simplified Size Projection relies on height and weight only, there is no need to calculate ratios and this step is skipped.

The height-to-body-measurement ratios used in Full Measurement Size Projection are based on the most current actual body measurement inputs for a child, e.g., current height to inseam, current height to waist, etc. A 48′ tall child with a chest circumference of 29.5′ would have a height to chest ratio of 1.627119. By multiplying the ratio by an estimated height (derived from the child's growth curve for height at a given future point in time or from the upper limit of a Brand's Size Parameters for height) it is possible to calculate an estimated body measurement for that point in time.

4. It is assumed that the size projection process will occur subsequent to the size calculation process and will rely on the same product type-specific body measurements as shown in FIG. 4. Using the Brand Size Code(s) previously found by the Size Calculation Process, the system will identify the size parameter upper limits of each body measurement (bXUL, where X is equal to the body measurement in question) needed to calculate the size code(s) that currently fit the child. If the child wears different size code(s) for each product type offered by a brand, it is possible that the system will need to calculate bXUL for a given body measurement more than once. For example, if a child wears a size 7 top and a size 8 bottom, bHeightUL will be determined separately for Tops and Bottoms to reflect the size parameter limits associated with each size.

5. Once upper limits and ratios have been calculated, the system calculates the height and weight, if applicable, at which the child is estimated to reach the UL of each body measurement associated with their current size code(s). The calculation varies by process type.

For Simplified Size Projection, the system determines both the height and weight at which the child is estimated to reach the bXPUL associated with their current size code(s), or the height and weight at which size change is estimated to occur. These target measurements are identified as eHX, and are calculated in the following way: bXPUL=eHX.

For the Full Measurement Size Projection, the system first determines both the height and weight at which the child is estimated to reach the bXPUL associated with their current size code(s), using the calculation above. Then the system multiplies each of the body measurement upper limits in the child's current size code(s) (bXUL, where X is equal to some body measurement) by the corresponding height-to-body-measurement ratio (rHX) identified in Step 3. This will determine the height at which size change is estimated to occur for a given body measurement. These measures are also identified as eHX, but the calculation differs as follows:

bXPUL*rHX=eHX.

6. The system will find the difference, identified as cDifX, between the growth percentile upper limit for the child's current height measurement and their current actual height measurements. The system does this by subtracting the child's current height (cX) from the height percentile upper limit (cXPUL), respectively, for the child's current age in months within the growth percentile curve for height identified in step 2. The calculation for finding this difference is cXPUL−cX=cDifX, where X is Height.

The system will then complete this step for weight, replacing height variables with weight variables to obtain both cDifH and cDifW. cDifW will always be found for Simplified Size Projection, but will only be performed for the Full Measurement Size Projection if weight is a body measurement variable for the brand and product for which size change is being projected.

7. The system then uses the eHX results determined in the step 5 to identify the month in which size change is expected to occur for each body measurement (e#X) needed to calculate a brand's size code(s).

Specifically, the system first determines #HeightPUL−cDifH≧eHX, where X is Height. It does this by subtracting cDifHeight from cHeightPUL. If the eHX for a given body measurement is greater than the difference, then the system will perform the same operation with each subsequent month—replacing cHeightPUL with #HeightPUL, where # is equal to some month in time—until the eHX is equal to or less than #HeightPUL−cDifH. In other words, the e#X for a given measurement is that in which #HeightPUL−cDifH≧eHX. The system then repeats this process to determine #WeightPUL−cDifW≧eHX, where X is Weight if weight is a body measurement variable for the brand and product for which size change is being projected.

For Simplified Size Projection, the system will conduct this step for height and weight only. For the Full Measurement Size Projection, this step is also completed for each relevant body measurement using the #HeightPUL−cDifH≧eHX calculation, where X is some body measurement other than height or weight. It is likely that the e#X will differ from body measurement to body measurement, but some body measurements may grow at similar rates, resulting in the same eHX result for those measurements.

If it is found that a child has already outgrown or is expected to outgrow a brand's size code along any body measurement in the current month, the system may bypass subsequent steps and, instead, notify the consumer of an emergent size change.

8. Next the measurement range or spread for the month of estimated size change (e#X) for each body measurement required by a projection process is calculated. The spread represents the total number of measurement units a child is expected to grow within the target month. To do this, the system will find the difference between the percentile upper limit for the month in which a size change is expected to occur (e#XPUL) and the previous month's upper limit (e#−1XPUL).

Using Simplified Size Projection, the system calculates e#HeightPUL−e#−1HeightPUL=HeightPULDif and e#WeightPUL−e#−1WeightPUL=WeightPULDif.

Using Full Measurement Size Projection, the above calculations are carried out. Then, for each body measurement X (i.e. sleeve length, chest, etc), XPULDif=e#HeightPUL−e#−1HeightPUL.

9. For each body measurement, the system determines the amount in inches or pounds—or in metric quantities, as appropriate—that the child is expected to grow within the target month (e#X), up to and including the target measurement eHX. This requires that the cDifX for a measurement be subtracted from the percentile upper limit for the month prior to the estimated size change (e#−1XPUL) for that measurement. Subtracting the result from the target eHX for a measurement equals the expected growth.

For Simplified Size Projection the amount of measurement units a child is expected to grow is calculated as eHHeight−(e#−1HeightPUL−cDifH)=InHeight and eHWeight−(e#−1WeightPUL−cDifW)=InWeight, respectively.

For Full Measurement Size Projection the amount a child grows may be measured in terms of both height and weight using the calculations described for the Simplified Size Project. Additionally, InHeight is calculated for all other body measurements as eHX−(e#−1HeightPUL−cDifH)=InHeight, where X is a given body measurement other than height or weight.

10. For each body measurement, find the multiplier (XMult), or percentage, used to calculate the number of days into the expected month of size change for the child to reach the target height or weight (eHX). To do this, divide InX by the corresponding XPULDif value found in step 9. InX/XPULDif=XMult.

11. Assuming 30 days in a month, multiply 30 times the XMult for each body measurement identified in the previous step to determine the number of days, rounded to the nearest whole number, into the target month (e#X) the size change is expected to occur. Days are calculated as XMult*30=e#XDay.

12. Calculate the date of expected size change within the target month (e#X) for each body measurement, height and weight. A calendar-based conversion mechanism will do this by:

a) Calculating the child's actual age in days using the most recent date of measurement.

b) Calculating the child's projected age, in days, on the first day of the month of size change (e#X) and adding the corresponding e#XDay value to it.

c) Subtracting the result of step 12a. from the result of step 12b.

d) Adding the resulting number of days to the most recent date of measurement and projecting the date in terms of a specific month, day and year for the expected size change.

e) Repeating these steps for the next body measurement.

13. This process is repeated for each brand that a consumer prefers, and for each size code within a brand that has been found by the Size Calculation Process to be a “best fit” for the child.

14. The body measurement with the earliest estimated date of change for a brand will trigger an automated message to the consumer at some interval prior to the projected date of change, notifying them of the projected change.

b. Presenting Size Change Projection Information

Size Change Projection information may be presented in a variety of ways. In one variation, a notification message is sent to a consumer containing just enough information that they will need to log into their account in order to review the full details of the size change. The account can provide size change information, prompt for updating information, and links to additional shopping resources. In another variation, a notification message may contain full details of the size change information, not requiring any action on the part of the consumer. These notifications or prompts can be through many different communication mediums such as SMS, email, voice or instant messaging.

The message can notify the consumer of the pending size change and why, as well as prompt them to update their child's measurements to identify the next best size for their child. Where a child fits in multiple sizes for a brand, such as Bottom Size 5 and Top Size 6, size change notifications will be sent for both product types using the earliest change in measurement associated with each product type.

In general, notification messages may contain a variety of information. Messages can be personalized to include the child's name and gender-specific pronouns. The date of expected size change may be specific, in a given week, or rounded in terms of early, mid, or late month. Notifications regarding multiple brands and expected size changes dates can be consolidated into a single message to avoid overwhelming the consumer with messages. Also, messages can include more information, such as the UL for the body measurement their child will outgrow, ULs for all other body measurements and the approximate date when the child will outgrow the size based on each measurement, and other size change details.

Size projection information may also be displayed with a clause that notifies a consumer that projected growth and size codes are merely estimates based on their own measurement entries and public health data. It should be presented with language that notifies a consumer that the information is not intended as a medical diagnosis or advice and that they should seek the care of a medical professional to better assess their child's growth. To help increase the accuracy of these projections, consumers may be asked to update their child's body measurements through direct communication or when they log into the system.

Assuming that size change notification is tied to apparel and footwear products in brands that a child currently wears, the system notifications can also include suggestions for products that match the projected size and the consumer's preferences. The product information may link to a system-driven website where the consumer may find those or similar products, a retailer's website, or a product-based search engine.

Size change projection information may also be shared with retailers or brands to support targeted marketing efforts, inventory management efforts, or to help them manage recurring delivery or subscription-type services.

c. Example of Size Change Projection

The following is an example of Size Change Projection using the Full Measurement approach:

1. Gather child-specific inputs:
Gender: Male
Child's DOB: Dec. 13, 2000
Date of measurement acquisition: Jun. 18, 2008
Approximate age in months: 90+
Current body measurements:
Height: 48′ tall Weight: 69 lbs Chest: 29.5′ Sleeve: 23′
Waist: 26.5′ Hip: 29.5′ Inseam: 23′

2. Determine child's Percentile Growth Curve for Height and Weight
Child's height falls within the 50th percentile (P50)
Child's weight falls within the 95th percentile (P95)

3. Determine height-to-body-measurement ratios using bXULs for each measurement.
rHChest: 48/29.5=1.627119
rHSleeve: 48/23=2.086957
rHWaist: 48/26.5=1.811321
rHHip: 48/29.5=1.627119
rHInseam: 48/23=2.086957
etc. for each body measurement for which the system has child-specific data

4. Identify the upper limits of each body measurement (bXUL) for a brand's size code(s). Note: Weight is not a body measurement variable for this brand's boys' Husky sizes and so Weight will not be used as a variable in this example.

Current size code(s) in Brand FantastiKids:
Tops 8+/M+
bHeightUL: 52′
bChestUL: 30′
bSleeveUL: 24.5′
Bottoms 7+
bHeightUL: 50′
bWaistUL: 26.5′
bHipUL: 30′

5. Project heights in terms of each body measurements by multiplying each bXUL by the corresponding ratio.

TOPS

| bHeightUL = eHHeight: | eHHeight = 52 |
|---|---|
| bChestUL * rHChest = eHChest: | 30″ * 1.627119 = 48.81356″ |
| | (eHChest is the height at which the |
| | child is expected to outgrow the |
| | limits of the chest measurement |
| | range for the child's current size |
| | in this brand) |
| bSleeveUL * rHSleeve = eHSleeve: | 24.5″ * 2.086957 = 51.13043″ |

BOTTOMS

| | |
|---|---|
| bHeightUL = eHHeight: | eHHeight = 50 |
| bWaistUL * rHWaist = eHWaist: | 26.5″ * 1.811321 = 48″ |
| bHipUL * rHHip = eHHip: | 30″ * 1.627119 = 48.81356″ |

6. Find the difference, identified as cDifX, between the growth percentile upper limit for the child's current height and their current actual height. cHeightPUL−cHeight=cDifH: 49.26217−48.0=1.26217′ (for a 90-month old male child within P50)

7. Identify the month in which size change is expected to occur for each body measurement.

cHeightPUL is equal to the UL for a child who's current age falls within 90 month range

Child's height falls within P50
cHeightPUL−cDifH: 49.26217−1.26217=48.00004
91HeightPUL−cDifH: 49.46185−1.26217=48.19968
92HeightPUL−cDifH: 49.66040−1.26217=48.39823
93HeightPUL−cDifH: 49.85778−1.26217=48.59561
94HeightPUL−cDifH: 50.05394−1.26217=48.79178
95HeightPUL−cDifH: 50.24883−1.26217=48.98666
96HeightPUL−cDifH: 50.44240−1.26217=49.18024 etc. . . .

TOPS

| | |
|---|---|
| eHHeight: 52″ | e#Height = 112th month |
| eHChest: 48.81356″ | e#Chest = 95th month |
| eHSleeve: 51.13043 | e#Sleeve = 107th month |

BOTTOMS

| | |
|---|---|
| eHHeight: 50″ | e#Height = 101st month |
| eHWaist: 48″ | e#Waist = 90th month (in this example, size change |
| | is expected to occur immediately, if it hasn't |
| | already) |
| eHHip: 48.81356″ | e#Hip = 95th month |

8. Determine the range or spread in height measurements for the month of estimated size change for each body measurement.

TOPS

| | |
|---|---|
| e112HeightPUL − 111HeightPUL = HeightPULDif: | 53.33929 − 53.16946 = 0.16983 |
| e95HeightPUL − 94HeightPUL = ChestPULDif: | 50.24883 − 50.05394 = 0.19489 |
| e107HeightPUL − 106HeightPUL = SleevePULDif: | 52.47568 − 52.29846 = 0.17722 |

BOTTOMS

| | |
|---|---|
| e101HeightPUL − 100HeightPUL = HeightPULDif: | 51.389201 − 51.20276 = 0.186441 |
| e90HeightPUL − 89HeightPUL = WaistPULDif: | 49.26217 − 49.06142 = 0.20075 |
| e95HeightPUL − 94HeightPUL = HipPULDif: | 50.24883 − 50.05394 = 0.19489 |

9. Determine the number of measurement units—in this case “inches”—that the child is expected to grow within the target month eHX.

TOPS

| | |
|---|---|
| eHHeight − (e#-1HeightPUL − cDifH) = InHeight: | 52 − (53.16946 − 1.26217) = 0.09271 |
| eHChest − (e#-1HeightPUL − cDifH) = InChest | 48.81356 − (50.05394 − 1.26217) = 0.02179 |
| eHSleeve − (e#-1HeightPUL − cDifH) = InSleeve | 51.13043 − (52.29846 − 1.26217) = 0.09414 |

BOTTOMS

| | |
|---|---|
| eHHeight − (e#-1HeightPUL − cDifH) = InHeight | 50 − (51.20276 − 1.26217) = 0.05941 |
| eHWaist − (e#-1HeightPUL − cDifH) = InWaist | 48 − (49.06142 − 1.26217) = 0.20075 |
| eHHip − (e#-1HeightPUL − cDifH) = InHip | 48.81356 − (50.05394 − 1.26217) = 0.02179 |

10. For each body measurement, find the multiplier (XMult), or percentage, used to calculate the number of days into the expected month of size change for the child to reach the target height (eHX).

TOPS

| | |
|---|---|
| InHeight/HeightPULDif = HeightMult | 0.09271/0.16983 = 0.54590 |
| InChest/ChestPULDif = ChestMult | 0.02179/0.19489 = 0.11181 |
| InSleeve/SleevePULDif = SleeveMult | 0.09414/0.17722 = 0.53120 |

BOTTOMS

| | |
|---|---|
| InHeight/HeightPULDif = HeightMult | 0.05941/0.186441 = 0.31865 |
| InWaist/WaistPULDif = WaistMult | 0.20075/0.20075 = 1 |
| InHip/HipPULDif = HipMult | 0.02179/0.19489 = 0.11181 |

TOPS

| | |
|---|---|
| InHeight/HeightPULDif = HeightMult | 0.09271/0.16983 = 0.54590 |
| InChest/ChestPULDif = ChestMult | 0.02179/0.19489 = 0.11181 |
| InSleeve/SleevePULDif = SleeveMult | 0.09414/0.17722 = 0.53120 |

BOTTOMS

| | |
|---|---|
| InHeight/HeightPULDif = HeightMult | 0.05941/0.186441 = 0.31865 |
| InWaist/WaistPULDif = WaistMult | 0.20075/0.20075 = 1 |
| InHip/HipPULDif = HipMult | 0.02179/0.19489 = 0.11181 |

11. For each body measurement, determine the number of days into the target month the size change is expected to occur.

TOPS

| | |
|---|---|
| HeightMult * 30 = e#HeightDay | 0.545890 * 30 = 16 days |
| ChestMult * 30 = e#ChestDay | 0.11181 * 30 = 3 days |
| SleeveMult * 30 = e#SleeveDay | 0.53120 * 30 = 16 days |

BOTTOMS

| | |
|---|---|
| HeightMult * 30 = e#HeightDay | 0.31865 * 30 = 10 days |
| WaistMult * 30 = e#WaistDay | 1 * 30 = 30 days |
| HipMult * 30 = e#HipDay | 0.11181 * 30 = 3 days |

12. Calculate the date of expected size change within the target month (e#X) for each body measurement using a calendar-based conversion mechanism.

Dec. 7, 2008 is the first expected date of change. Applies to both chest and hip measurements.

13. Repeat for entire process for each brand.

14. Notify the consumer of expected size changes in all brands 2 to 3 weeks prior to expected date of change.

For FantastiKids=˜November 15 notification date

“Your child is expected to grow out of their current FantastiKid 's Tops size (8+) in early December because of their chest measurement.

Your child is expected to grow out of their current FantastiKid 's Bottoms size (7+) in early December because of their hip measurement.

But, FantastiKid 's clothing may still be appropriate for your child's weight until mid-January.”

V. Customizing Size Calculation and Projection Findings

a. Child-specific Account Creation

While a simple one-time size calculation can be carried out by the system, more typically a consumer will create an account in which they establish a profile for a child. It is assumed that an account may store profiles for a plurality of children. According to one aspect of the invention, a database can store account information including, but not limited to personal identifiers such as names for both the consumer and the child or children for whom the account is being created, a child's body measurements and current sizes for a plurality of product types and brands, and which allows growth, fit preference and size information to be tracked and adjusted over time.

The consumer will use the account to access the system, allowing them to update and maintain information about their child, grant viewing or editing rights to other consumers, and utilize data storage, size calculation, growth and size change projection, product recommendation, and other functions of the system. The account will be secured with a password or other identifier to prevent unauthorized access of account information, and the consumer will have the ability to grant viewing and editing rights to other individuals, such as gift-givers or other child care-givers.

The system requires the person responsible for the child account, typically a parent or other care-giver, to enter information about the child such as birth date, gender, and required body measurements. The consumer will also input other search requirements, such as product type, brand, or retailer. These variables can be used to determine the most appropriate size in a brand for a child when compared against a brand's size parameters. The child's account will remain in the system for an extended period of time and will provide clothing sizes to interested parties such as relatives and friends who are purchasing gifts for the child.

As not all children grow at the same rate, the system will allow the person responsible for the child's account to log into the account and update information about the child. This information may be used in multiple ways to correct the predicted height and weight for the child. One method of correcting the predicted weight and height for the child would be to adjust the weight and height percentile assigned to the child, and thus adjust the future predicted sizes as well as the presently recommended size. Another method of adjusting the predicted weight and height of the child would be to adjust the rate of change predicted by the weight and height percentile tables or charts according to the particular child. Thus, if a child grows more slowly or more quickly than is predicted by the charts for their percentile, multiple data points of height and weight, as entered by the person responsible for the account, could be used to adjust the prediction and accommodate a quicker or slower growth rate.

As such, the child's account would, at any date, provide recommended clothing sizes for the child for preferred brands, based on current actual body measurements as entered by the consumer responsible for the account. The system may also provide a recommended clothing or footwear size for the child based on the body measurements projected by the system using growth tables or charts. Thus, the account aids consumers in purchasing the correct sizes of clothing or footwear for a child.

According to one aspect of the invention, the consumer may access their account data through a system-driven website, a retailer's site, a desk-top widget on their home computer or mobile telephone or PDA device, a widget on a third party blog or social networking site, a brick-and-mortar location through a kiosk or some other digital mechanism that employs the system, enabling them to access their child's size information effectively.

According to another aspect of the invention, the account can employ a database to store a consumer's purchase history and shopping preferences, such as product descriptors, styles, fabric preferences and other factors that may affect size calculation. Purchases may include those made on a system-driven website, a retailer's site that uses the system, brick-and-mortar based purchase made using account details or a preferred shopper type card, or other retail purchases entered into the system manually by a consumer. When a consumer holds an account, they may log in to the system view purchases made at specific retailers in the past. The system can also retrieve preferences and previous purchases and combine this information with size calculation and projection data to suggest appropriate sizes and products to the consumer. The consumer can have confidence in the selection because the system already pre-selects clothing that the consumer may like in the appropriate sizes, avoiding consumer confusion over size and decreasing the amount of time they search for a type of product.

The system may use individual and aggregate data to more accurately calculate sizes and project size changes for specific brands, project specific body measurements, and improve calculation and projection processes overall. Additionally, the system may provide such data with retailers and brands for their use in marketing, inventory management, and product development efforts.

b. Modifying Factors

Several factors may affect the results of the Size Calculation and Project Processes, including but not limited to fabric type, whether an item has been pre-shrunk, personal characteristics such as whether a child is still in diapers, product cut (such as if a product is intended to have wide legs versus fitted legs or if a product is cut large or small), and other such factors. These factors can be integrated into the size calculation and selection process where data is available to do so. For example, a child's size medium tee made of 100% cotton that has not been pre-shrunk may be ½ to 1 size smaller after washing than the size parameters suggest.

Where manufacturers provide information related to their fabric processing and shrinkage factors, or consumers provide sufficient feedback on items to standardize the effects of these factors on fit, these elements can be included in the size calculation process to produce a more accurate size recommendation.

The system can prompt consumers to identify whether their child is still in diapers or if they prefer toddler sizing relative to kid sizing, allowing for size recommendations that cater to very young children for whom regular size clothing might not yet be appropriate.

Also, since many brands have different styles of clothing that yield different looks or may be appropriate to different body shapes, product cut or style can be incorporated into size information to provide a the consumer with a size code that is not only the right size, but with information about a brand's products that may help them find individual styles within a brand—where applicable—that will look and feel better on their child than other styles. For example, if a brand cuts their sizes small, the system might suggest a larger size code if the child is close to the upper limits of the size code they fit based on current body measurements.

Other factors may further modify size code calculation and suggestions.

c. Personal Preferences

Consumers may also use a child's account to store preference information to aid in shopping for particular products and brands, such as preferred retailers; favorite colors, styles, cuts, fabrics, and decorative elements; price range constraints; fit information and product reviews; weather and seasonal information for the area where the child lives, etc.

The system may rely on a consumer-generated weighting system, comprising such decisions as giving more weight to the fit of certain body measurements, or preferring oversized clothing to “grow into.” The latter may help prevent the system from suggesting sizes that are too small and, instead, suggesting larger sizes for customer profiles that have not been updated recently.

Such personal preferences can be used by the system to recommend apparel products that are not only the most appropriate size, but which also match the consumer's personal shopping preferences or goals.

These preferences may be used to delimit product search results, supply dynamic product recommendations, inform site-based advertising, adjust communications between the system and a consumer, create a public gift registry, and to help with other shopping, size calculation, product recommendation, or communication activities that may be possible.

VI. Interactions with and Uses of Invention

a. Utilizing the System for Advanced Notification of a Projected Size

According to one aspect of the invention, a consumer may select a future date and the system will calculate the brand size code(s) by product type that is estimated to fit their child on that date. Whereas the basic Size Change Projection Function projects when a child is expected to outgrow their current size code for a specific brand and product type, this variation allows a consumer to select a future point in time, project a child's growth trajectory, and calculate a brand and product-specific size code(s) for the desired timeframe.

b. Utilizing the System for Recurring Product Delivery

According to another aspect of the invention, a subscription, or recurring delivery, service for children is created. The delivery service may apply to any garment, footwear, or other consumer product that can be associated with age and size information for a child. A consumer purchases a subscription service for a child (e.g. one that sends a new t-shirt for a child with every estimated size change, or a new age-appropriate toy each quarter, etc.) and creates an account for the child which enables the system to monitor the child's growth and deliver the age or size-appropriate goods. The consumer account information may comprise such things as contact information, product selection, delivery or shipping dates, payment information and child-specific inputs required to project the child's growth. The system then uses the information to determine product needs for the child and support processing of sequential shipments for the appropriate delivery dates.

Child-specific inputs comprise a broad set of data that describes not only the physical characteristics of the child, like gender, date of birth, and body measurements, but may also include information such as color or style preferences, local weather expectations, how conservative size estimation should be, and other shopping preferences related to the variety of products available for recurring shipment.

Once a shipment is sent, the system can prompt the consumer to further customize the child's profile and account information to improve content of subsequent deliveries. These prompts can be through many different communication mediums such as SMS, email, voice or instant messaging. The consumer then has the ability to update the child's body measurement and fit information, preferences, etc. based on the items received. This presents another data point in the specific information available to the invention.

Before the next shipment is sent, the system may prompt the consumer once or multiple times to update measurement and preference information or provide feedback on the delivery contents. Should the data be updated, the system relies heavily upon the new data to determine sizes, product types, etc. to send to the consumer. If the data is not updated, the system uses the consumer's existing account information and, for apparel or footwear, population-based child growth trends applied to the most recent data points given by the consumer to the system.

Population-based child growth data can be obtained through clinical, aggregate or historical data sets from proprietary or publicly-available sources such as the National Center for Health Statistics, pediatric growth charts or even estimated through enough observed consumer action in the system.

According to another aspect of the invention, the system enables better Just-In-Time (JIT) inventory system, in which a retailer carries only the amount of inventory needed for the next shipment. The system allows this because it uses consumer purchasing patterns and subscription plans with projected age and size information to estimate the inventory needed to fill consumer orders at a given point in time. In other words, once the system decides on sizing requirements for each subscription consumer, the system estimates the amount of clothing or goods to order for each size and product style to satisfy consumer orders. This estimation is communicated to the purchasing agent or purchasing module, such that it can make a more informed decision about how many of specific items to order.

The system repeats this process following each shipment. Consumers are reminded to update their profile, and new consumers enter information into the system.

c. Other System Applications

According to one aspect of the invention, a system-driven website may be created to serve as a central location for calculating and projecting size information, for managing consumer accounts and child profiles, for suggesting products consistent with consumer preferences and child sizes, and providing consumers with resources about apparel and footwear fit, sizing guidelines, specific brands and product types, and other information.

Beyond the system-driven website, there are a variety of ways in which the present invention may be applied and in which users may interact with these application. Following is a description of how consumers, retailers, and brands/manufacturers may interact with or use the present invention. This description represents some of the possible interactions with and applications of the described invention, and is in no way intended as complete.

Consumer Interaction with the System

The system is intended to be used in conjunction with commercial activities in which a consumer would calculate the best size of apparel or footwear in a brand for their child or a gift recipient based on the child's actual size. It is also intended to project the date when a child is expected to outgrow that current size or to calculate the child's size for some future date based on their estimated growth trajectory. As such, consumers will interact with the system in a variety of ways and locations, including, but not limited to, the following:

A: As an account-holder who wishes create an online account in which they may store their child's growth information, current sizes for multiple preferred brands and product types, projected growth and sizes change information, shopping preferences (such as preferred retailers, styles, price ranges, and fit information), purchase histories, and other information related to apparel and footwear sizing for a child or children.

B: As a customer on a retailer's site, where they can determine accurate size information at a brand and product level either by entering a child's measurements into the product screen for a quick calculation or by logging in with their personal account information to an interface that resides on the retailer's site, allowing them to retrieve a child's data automatically. This may help a retailer reduce the time and cost associated with the return of products that do not fit their child, and it may help increase consumer confidence in the online sales process.

C: As a consumer using a size calculation widget within a social networking community to identify a child's current size, find products by size, suggest products by size, showcase a child's current closet, or other community shopping activity.

D: As a gift-giver searching for the ideal clothing gift for a child on a system-based website, a retailer's site, or through a third-party gift registry service that uses the invention.

E: As a customer in brick-and-mortar retail location who uses a kiosk to identify a child's size in one or more of the store's brands or to log in to their account or swipe a customer card that allows them to retrieve the information through a network.

F: Or some other yet-to-be-determined fashion

Retailer Interaction with System

The system is also intended to be used by retailers to help them make customized size information readily available to their consumer base in a way that inspires confidence in purchasing children's wear online, increases the likelihood that items will fit a child, and reduces the potential for returns. Given this objective, Retailers may interact with and use the system and resulting data in several ways, including but not limited to the following:

A: Retailers may employ the system in their online or in brick-and-mortar locations by making a size calculation module available to their customer base through a website or kiosk, allowing consumers to immediately and accurately determine the best size for their child at the point of purchase.

B: The invention allows retailers to provide consumers with actual or approximate sizing based on a child's birth date, gender and measurement information. This is helpful for companies that offer clothing through the internet, in a brick and mortar retail environment when a child is not present, or some other distribution channel in which a child may not be able to try the clothing on before it is purchased.

C: The invention allows retailers to collect and analyze data about customer sizes, growth trends, and shopping preferences, and other factors which may help them better predict consumer needs and interests and to manage product procurement guidelines each season.

D: The invention can also help companies that have a loyal customer base use aggregate child data, size change information, and shopping preferences to manage inventory and order fulfillment more effectively. This is particularly the case with frequent buyers such as those that engage in membership, rewards or frequent purchase programs, as well as with customers that purchase product subscriptions in which a company would send recurring shipments of children's apparel that is appropriate to measurements, age, and gender at the time of delivery. In these cases, retailers can use the actual or estimated size information and anticipated product demand to predict inventory requirements and fulfill orders that are likely to fit well.

E: How consumers use the invention and the data they create through that use may be used by retailers to make targeted product recommendations to individual account-holders, study aggregated shopping patterns among a consumer base, or to inform clothing subscription services in which repeating deliveries of size-appropriate clothing are sent to a consumer. Similarly, the account information may be used by retailers for purposes of targeted online or direct mail or email advertising.

F: The invention may be useful as a service or marketing tool on websites that support retailers by providing information, resources, and advertising to a retailer's target market. For example, the invention could be used by a children's product review website as a way to offer content to their readership and/or generate advertising dollars from manufacturers' whose sizes are included in the service's data set.

Brand and Manufacturer Interaction with the System

The same interactions and uses that apply to Retailers are applicable to Brands and Manufacturers that have retail outlets. Where no retail outlet exists, Brands and Manufacturers may benefit from the data generated by the invention in several ways, including but not limited to the following:

A: To gain better insight into the customers who buy their products at partnering retail locations.

B: To improve merchandising and marketing efforts directed at target consumers.

C: To support advertising efforts

D: To better reach brand loyalists

E: Or other potential uses

It is thus observed how the system and method of calculating and projecting changes in children's apparel and footwear sizes improves on prior methodologies by addressing the specific needs of growing children. It will improve upon results provided by prior art for a range of product types, garment and footwear styles, consumer preferences, and sizes by incorporating factors that are specific to children's wear and children's growth patterns. Additionally, the system will provide consumers with appropriate size information for a child now and into the future, and it will provide retailers, brands, and manufacturers with the ability to better meet consumer expectations and inform consumers of products that are appropriate to a child's measurements and age-specific apparel needs over time

It is thus observed that the present methods and system are useful to determine appropriate sizes of clothes for children based on the child's actual or projected measurements and based on brand or clothing specific information. The present methods are thus particularly useful in purchasing clothes online, and may be used to calculate clothing sizes for subscription services, gift giving, or online purchasing.

Typically, a person would interface with a computer, such as a web server handling the online sales for a company, in order to select clothing sizes and make purchases. The person would provide information specific to a particular child, such as height, weight, waist size, etc. as discussed. Hereafter, the terms height and weight are referred to for simplicity, but it is appreciated that the methods also address other fit measurements, such as waist, sleeve length, chest size, etc. as is desired and appropriate to a particular item of clothing. The person may also enter a desired type or style of clothing. This information is received by the computer.

The child information which is entered will depend on the age of the child and the desired clothing. Babies and infants may require only the entry of height (length) and weight. When a particular child is about 2 years old (or reaches a certain size which would result in clothing for a 2 year old child), additional measurements may be desired for optimal clothing fit. The computer may then prompt the customer for additional measurements such as arm length, leg length, waist size, etc. as may aid in providing properly sized clothing.

The computer then searches through a database of clothing information and finds potential items of clothing based on the child's information and based on information about the clothing. The computer would match the child information with the clothing information, ensuring that the child falls within the acceptable ranges for the clothing, such as minimum and maximum weight and height. The computer may find various brands of clothing which will fit the child, introducing the customer to brands they may not be familiar with. The computer may determine that certain brands may fit the child better, as may be the case for a child which is taller, more slender, etc.

The computer may prompt the customer for additional input as may be necessary for the desired item of clothing, such as the leg length or waist size. Alternately, the computer may ask the customer questions which produce this information without requiring actual measurements. These questions may be questions about how the clothing typically fits the child such as “Are the child's pants usually too short, too long, or just right?” Questions such as these may allow the computer to determine if the child's body proportions (such as leg length or arm length relative to height) are shorter or longer than average.

Additionally, the computer may ensure that there is a growth allowance, i.e. a specified amount of room for a child to grow, in either or both height or weight measurements.

The growth allowance may be determined in a number of different ways. The growth allowance may be a percentage of the height/weight range for the clothing, or may be a fixed amount. The growth allowance may be defined as a fixed amount which varies according to the child size. Thus, a larger height growth allowance may be used during periods of faster growth (as determined by average growth rates) and a smaller height allowance may be used during periods of slower growth. Additionally, the growth allowance may be a period of time, requiring that the clothing will fit the child for at least two months, etc. The customer may be allowed to specify a time period as well. Thus, the customer may request that the clothing will fit for at least four months in order to allow for growth, or may request that the clothing fit very well now (or at a future date) with no requirement for fitting well afterwards, as such may be the case in purchasing a particular item of clothing for a special occasion such as a holiday or family event. The computer thus may return to the customer particular items of clothing which will fit the child, and which allow for growth of the child.

Similarly, the customer may enter a date when the clothing will fit. The customer may request clothing that will fit now, soon (such as within a month from now), or at a date in the future. In this way, the customer may decide whether they need clothing right away, want the clothing soon but want the child to be able to wear the clothes as much as possible, or will need clothing at a future date.

According to a preferred embodiment of the invention, multiple child measurements may be required to provide a proper clothing fit. Thus, the computer may require two measurements, such as height and weight, in order to calculate a good clothing fit for a child, and may require additional measurements such as chest size, arm length, inseam, etc. to provide a more accurate fit.

The computer will typically use a growth chart (or a database or numerical equivalent thereof) as is shown in FIG. 6 to calculate the growth of the child. This method allows the computer to project reasonably accurate growth for desired dates in the future. Where a customer has created an account on the computer in order to use the computer and clothes fitting methods on an ongoing basis, the computer may have access to additional stored past height/weight data points for a particular child which is usable for more accurately calculating future growth.

The computer may use multiple height/weight data points to more accurately calculate further growth. The computer may adjust the slope of the projected growth curve depending on whether a particular child grows faster or slower than average children. Alternatively, the computer may determine which percentile of height/weight the child fits into at each particular height/weight data point and track changes in numerical percentile over time. Changes in percentile (i.e. the child has changed from the 57th percentile in height when 3 years old to where the child is currently at the 55th percentile in height at 4 years old) may be used to adjust the projected height/weight at a future date. Thus, for the preceding example, the child's height one year in the future may be projected by looking at the growth chart for the 53rd percentile for a 5 year old child.

Thus, in the context of a subscription service, the computer may project when the particular items of clothing will fit the child. Thus, the computer may project approximate dates when a child may start and stop wearing a particular item of clothing. The computer may use the growth charts to calculate when the child will reach a height or weight which will outgrow current cloths or grow into new clothes, and send clothes accordingly. The computer may then automatically send items of clothing to a child as the child outgrows current clothing and needs new clothing.

Because the computer is able to project the growth of the child, the computer may be able to project the height/weight of the child at any desired date in the future. Thus, a customer may request that the computer project the size of the child at a desired date in the future in order to buy clothes now that will fit in the future. Thus, the customer may determine the proper size of summer clothes now which will fit the child next summer. This is useful in situations such as a gift giving context, back to school shopping, or where a person is shopping end of season sales and desires to purchase clothing for next year. The computer may thus be located in a store kiosk which customers may use to purchase accurate sizes. In these situations, the customer may not need to create an account, but could simply enter child height/weight, the desired time for the clothing to fit the child, and possibly the items of clothing that the person is interested in purchasing. The computer may then provide the customer with the projected child height/weight at the future date and the appropriate size of clothing to purchase.

According to another aspect of the invention, the computer may receive customer feedback about how well a particular item of clothing fit a child. The computer may process customer feedback and associate the feedback with the particular brand, category, or item of clothing. This information may thus be used to alter the suggested size of clothing. Thus, the computer may learn from customers that brand X of clothing tends to be slightly smaller than average while brand Y of clothing tends to be slightly larger than average. The computer may thus adjust to provide more accurate clothing size recommendations.

The present invention is useful as it accounts for the differences in size between brands of children's clothing and accounts for the different types of children's clothing (such as infant, toddler, child) and provides the consumer with a recommendation of which particular item of clothing will best fit their child. This is particularly useful to customers, as children will often fall between toddler and child sizes or different child sizes, for example, and the appropriate choice will depend on the particular brand of clothing or how much growth allowance the customer desires.

There is thus disclosed an improved method and system for determining, tracking, and projecting children's clothing sizes. It will be appreciated that numerous changes may be made to the present invention without departing from the scope of the claims.

What is claimed is:

1. A method for determining children's clothing sizes comprising:
storing in a computer brand and size specific measurement data for particular sizes of clothing for at least one brand of clothing;
storing in the computer statistical growth data for children in general;
the computer receiving from a user child specific data including body measurement data for a particular child;
the computer receiving a future date from the user;
the computer calculating the size of the child on the future date based on the child specific data and the statistical growth data;
the computer calculating a size of clothing for a particular brand of clothing which will fit the child on the future date; and
the computer providing the size and brand of clothing to the user.

2. The method of claim 1, wherein the method comprises:
storing in the computer brand and specific measurement data for particular sizes of clothing for a plurality of brands of clothing; and
the computer calculating the brand and size of clothing which will best fit the child on the future date.

3. The method of claim 1, wherein the method comprises:
the computer calculating a size of clothing which will fit the child on the future date such that the size of clothing reflects a predetermined growth allowance such that the clothing will fit the child for a predetermined amount of growth.

4. The method of claim 3, wherein the growth allowance is a period of time during which the clothing will fit the child.

5. The method of claim 3, wherein the growth allowance is an amount by which a child body measurement may increase.

6. The method of claim 3, wherein the user may input a desired growth allowance.

7. The method of claim 1, wherein the method comprises:
the computer storing, for particular types of clothing such as shirts, pants, etc., child specific body measurements which a user must enter in order to determine the appropriate size of clothing for a child.

8. The method of claim 7, wherein the method further comprises;
the computer storing, for particular types of clothing, child specific body measurements which a user may optionally enter to better determine an appropriate size of clothing for a child.

9. The method of claim 1, wherein the method comprises:
a user entering future dates on which they desire clothing to be sent automatically;
the computer calculating the appropriate size of clothing for the child on said future dates; and
the computer automatically triggering the shipment of clothing to the child on the future dates based on the calculated sizes.

10. The method of claim 1, wherein the method comprises:
the computer receiving child specific data including two sets of actual body measurement data for a particular child corresponding to two different dates; and
the computer calculating the body measurements of the child on the future date based on the child specific data and the statistical growth data, the calculated size of the child being adjusted based on the two sets of body measurements to more accurately project the body measurements of the child.

11. The method of claim 1, wherein the method comprises:
the computer receiving from the user various additional child body measurements other than height and weight;
the computer correlating said other body measurements to the height of the child;
the computer calculating the height of the child at a future date based on the statistical growth data; and
the computer calculating the other body measurements at the future date based on the calculated height at the future date and the correlation between the other body measurements and height received from the user.

12. A method for determining children's clothing sizes comprising:
providing a computer, the computer comprising:
brand specific clothing measurement data for particular sizes of clothing for at least one brand of clothing;
statistical growth data for children in general;
the computer receiving child specific data from a customer, said child specific data including the child's date of birth, gender, and actual height, and weight;
the computer calculating a size of clothing which will fit the child, the size of clothing being calculated for a specific brand of clothing from the brand and size specific measurement data and from the child height and weight data; and
the computer providing the brand and size of clothing to the customer.

13. The method of claim 12, wherein the method comprises:
the computer calculating the size of clothing so as to provide a predetermined growth allowance, said growth allowance providing that the child may grow for a predetermined period of time or increase in measurement such that the calculated size of clothing will still fit the child during said growth.

14. The method of claim 13, wherein the customer may provide the growth allowance to the computer.

15. The method of claim 12, wherein the method comprises:
the computer receiving a future date from the customer;
the computer calculating, for the future date, the child's height and weight from the child specific data and from the statistical height and weight growth data;
the computer calculating, for the future date, a brand specific size of clothing which will fit the child from the brand and size specific measurement data and from the child height and weight data.

16. The method of claim 12, wherein the computer comprises brand and size specific clothing measurement data for particular sizes of clothing for a plurality of brands of clothing, and wherein the method comprises the computer calculating a size of clothing which will best fit the child, the size of clothing being calculated for a specific brand of clothing from the brand and size specific measurement data and from the child height and weight data.

17. The method of claim 12, wherein the child specific data further includes at least one child body measurement other than height and weight.

18. The method of claim 17, wherein the computer comprises, for particular types of clothing, brand specific measurement data particular to that type of clothing and wherein the at least one child body measurement other than height and weight corresponds to the measurement data particular to a type of clothing for which the customer is searching.

19. A method for determining children's clothing sizes comprising:
providing a computer comprising:
brand specific measurement data for particular sizes of clothing for at least one brand of clothing;
statistical growth data for children in general;
the computer receiving from a customer child specific data including date of birth, gender, and actual height, and weight; and
the computer calculating the projected growth of the child based on the statistical growth data and the child specific data; and
the computer delivering to the customer brand specific clothing size information based on the child specific projected growth.

20. The method of claim 19, wherein the method further comprises:
the computer calculating, for the specific child, a date upon which the child is projected to grow out of a brand specific size of clothing.

21. The method of claim 19, wherein the method further comprises:
the computer calculating, for the specific child, a date upon which the child is projected to grow in to a brand specific size of clothing.

22. The method of claim 19, wherein the method further comprises:
the computer calculating, for the specific child, dates when specific sizes of clothing will fit the child based on the calculated growth of the child.

23. The method of claim 19, wherein the computer comprises, for particular types of clothing, brand specific measurement data particular to that type of clothing and wherein the at least one child body measurement includes a measurement other than height and weight which corresponds to the measurement data particular to a type of clothing for which the customer is searching.

24. The method of claim 19, wherein the child specific data further includes at least one child body measurement other than height and weight, and wherein the method further comprises:
the computer correlating the at least one body measurement other than height and weight to the height of the child;
the computer calculating the projected height of the child at a future date based on the child specific data;
the computer calculating the projected at least one body measurement other than height and weight at the future date based on the projected height at the future date and the correlation between the at least one body measurement other than height and weight and the height; and
the computer delivering to the customer brand specific clothing size information based on the child specific projected growth including the projected at least one measurement other than height and weight.

25. The method of claim 19, wherein the method further comprises:
the computer automatically triggering shipment of clothing to the child at least one future date based on at least one of the group consisting of: the child growing out of current clothing and the child growing into a predetermined clothing size.
